(19) United States
(12) Patent Application Publication
(10) Pub. No.: US 2008/0217226 A1
(43) Pub. Date: Sep. 11, 2008

(54) ORNAMENTAL POND FILTER APPARATUS

(76) Inventor: C. Bradley Porter, Bixby, OK (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(21) Appl. No.: 12/044,710

(22) Filed: Mar. 7, 2008

Related U.S. Application Data
(60) Provisional application No. 60/893,490, filed on Mar. 7, 2007.

(51) Int. Cl. C02F 1/00

(52) U.S. Cl. 210/170.02; 210/167.01; 210/170.09

(57) ABSTRACT

According to a first aspect of the instant invention, there is provided herein a new solids separator which will preferably be used in conjunction with a skimmer/filter combination of the sort traditionally utilized in ornamental ponds. According to a second aspect of the instant invention, there is provided herein an aerator for use with an ornamental pond or the like. Finally, in still another preferred embodiment there is provided a diffuser which is designed to provide a smooth flow of fluid therefrom when it is used as, for example, a waterfall feature.

The present invention relates to the general subject matter of maintaining artificial aquatic systems and, more particularly, to methods and apparatus for filtering or purifying the water in an aquatic life support system such as an ornamental pond.

### BACKGROUND OF THE INVENTION

Ornamental pools, ponds, and similar water-filled structures are familiar fixtures in many homes and businesses. These bodies of water provide a pleasant environment for the occupants of the adjacent structure and, in some cases, create habitats for birds, small mammals, and various reptiles and amphibians. However, because these bodies of water are closed systems, some mechanism must be established to keep the water that is contained therein from becoming fouled and stagnant.

One such apparatus that is frequently found used in connection with captive pools of water is a filtering/aerating system. In a conventional arrangement, the water in the pond is continuously circulated through some combination of skimmers and filters, thereby reducing the level of particulate mater suspended within the water. Additionally, such water movement is usually designed to oxygenate the water, thereby making it possible for the pond to support aquatic life, such as fish, water plants, amphibians and such.

The pond filter takes water from the pond and subjects it to a filtering process before returning it to the pond from whence the water was drawn. Preferably, the filter will be outfitted with filtering media (such as lava rocks, coarse nylon mesh filter mats, etc.) and water will be passed through the filtering media before it is returned to the pond. Additionally, the filter may be adapted to return water to the pond in the form of a waterfall, which waterfall has both aesthetic as well as functional (e.g., aerating the pond water) value. All of this is well known.

However, the problem of maintaining the quality of water in ornamental ponds, while simple conceptually (e.g., filter and aerate) is never quite so easily implemented in practice. For example, debris will tend to accumulate in the filter media which can, over time, drastically reduce its effectiveness. In some instances, the filter can become blocked to the extent that the flowing water must force a path around the periphery of the filter, thereby completely (or nearly so) thwarting its purpose. As a consequence, the pond owner will be tasked periodically with the chore of removing and cleaning the filter media. Of course, that may prove to be a difficult and messy task depending on the location of the filter. For example, in some instances the filtering component may be hidden from view by rocks, dirt, etc., in order to give the pond a more natural appearance. This camouflage will typically need to be removed prior to accessing the interior of the filter, further increasing the difficulty of the procedure.

Additionally, aeration of the circulated water may not occur to the extent desired. Keeping the water aerated is necessary for reducing algae growth, increasing water clarity, encouraging aerobic bacteria colonization, and generally for promoting healthy aquatic life. However, conventional skimmer/filter combinations may not always provide sufficient aeration. Even those that utilize artificial waterfalls may need additional infusions of oxygen, depending on the size of the pool, the amount of aquatic life, the volume of the waterfall, etc.

Further, conventional pond filters are subject to a number of problems. First, these devices have heretofore not provided sufficient sedimentation opportunities for the pond water. That is, water that is drawn into the filter will usually contain a variety of heavier waste particles (e.g., fish waste, uneaten fish food, leaves, etc.) that tend to clog the filter media when they are entrapped thereby, which necessitates cleaning the media earlier than might otherwise be desired. Each time such a filter is cleaned, however, the bio-activity that is taking place within the media is placed at risk. However, if a proper sedimentation environment were present within the filter, i.e., if the flow of water therethrough were slowed to the point where these sorts of heavier waste particles were allowed to settle to the bottom of the filter before the water reached the filtering media, the filtering media would need to be cleaned less often.

By way of general background, the disclosures contained within U.S. Pat. Nos. 6,461,501 and 6,979,401 are suggested reading and are incorporated herein by reference as if fully set out at this point.

Heretofore, as is well known in the ornamental ponds arts, there has been a need for an invention to address and solve the above-described problems. Accordingly, it should now be recognized, as was recognized by the present inventor, that there exists, and has existed for some time, a very real need for a device that would address and solve the above-described problems.

Before proceeding to a description of the present invention, however, it should be noted and remembered that the description of the invention which follows, together with the accompanying drawings, should not be construed as limiting the invention to the examples (or preferred embodiments) shown and described. This is so because those skilled in the art to which the invention pertains will be able to devise other forms of this invention within the ambit of the appended claims.

### SUMMARY OF THE INVENTION

According to a first aspect of the instant invention, there is provided herein a new sedimentation chamber which will preferably be used in conjunction with a skimmer/filter combination of the sort traditionally utilized in ornamental ponds. In a preferred embodiment, the instant vortex solids separator utilizes directed fluid flow to create a peripheral water circulation within a generally cylindrical body. At the lower terminus of the vortex filter, the base will preferably increase in diameter, thereby creating a zone of relatively immobile water. As water enters this zone, any solids suspended therein will tend to fall to the bottom of the separator. Then, the water which has been relieved of much of its solid contaminants will then tend to make its way up through the center of the separator where it will preferably pass through a mat-type filter before being discharged either back into the pool or into another water treatment component.

According to a second aspect of the instant invention, there is provided herein an aerator for use with an ornamental pond or the like. In a preferred embodiment, water will be brought into an accumulating structure such as a filter via the instant aerator. In the preferred embodiment, the instant invention aerates the water, preferably through the use of gravity, by allowing it to fall through a rectangular aperture into a cylindrical pipe that continues vertically downward for some distance into a water reservoir before curving into a horizontal orientation. The horizontal component of the instant aerator is preferably equipped with a series of holes that allow water and oxygen to escape into the water reservoir. Preferably the water reservoir that is to be aerated will be a filter of some sort.

Finally, in still another preferred embodiment there is provided a diffuser which is designed to provide a smooth flow of fluid into a structure such as a waterfall. Preferably, the diffuser will contain a plurality of horizontally spaced apart vertical dividers, some of which extend upwardly into the interior of the diffuser from its floor and others of which extend downwardly from its cover, the net effect being to force water flowing therethrough to move in a non-linear fashion, thereby slowing its progress through the diffuser and resulting in a more uniform distribution of water that originates as a point source.

The foregoing has outlined in broad terms the more important features of the invention disclosed herein so that the detailed description that follows may be more clearly understood, and so that the contribution of the instant inventor to the art may be better appreciated. The instant invention is not to be limited in its application to the details of the construction and to the arrangements of the components set forth in the following description or illustrated in the drawings. Rather, the invention is capable of other embodiments and of being practiced and carried out in various other ways not specifically enumerated herein. Additionally, the disclosure that follows is intended to apply to all alternatives, modifications and equivalents as may be included within the spirit and scope of the invention as defined by the appended claims. Further, it should be understood that the phraseology and terminology employed herein are for the purpose of description and should not be regarded as limiting, unless the specification specifically so limits the invention. Further objects, features, and advantages of the present invention will be apparent upon examining the accompanying drawings and upon reading the following description of the preferred embodiments.

### BRIEF DESCRIPTION OF THE DRAWINGS

Other objects and advantages of the invention will become apparent upon reading the following detailed description and upon reference to the drawings in which:

FIG. 1 contains a schematic illustration of a preferred embodiment of the instant vortex separator as it might be utilized in practice.

FIG. 2 illustrates a snout for use with the vortex separator or other water conditioning device, wherein ultraviolet lights are placed within the water's path.

FIG. 3 contains still another preferred embodiment of the instant invention, wherein the drop chamber of FIG. 1 includes a UV light.

FIG. 4 illustrates a plan view of a preferred drainage pattern for use in the base of the vortex separator.

FIG. 5 contains another preferred vortex separator embodiment that additionally incorporates one or more UV lights and an aerator within its snout.

FIG. 6 illustrates a side view of a preferred aerator embodiment.

FIG. 7 contains a schematic illustration of a top view of the embodiment of FIG. 6 with the filter media removed.

FIG. 8 illustrates one preferred configuration of a diffuser/aerator combination.

FIG. 9 contains a schematic illustration of a cross view of the diffuser of FIG. 8 a cross sectional view of the embodiment of FIG. 8.

FIG. 10 contains an illustration of a preferred diffuser embodiment which more clearly illustrates its 3-dimensional structure.

FIG. 11 contains a side view of a preferred vortex filter which utilizes continuous ridges to direct water toward the base of the filter.

FIG. 12 illustrates a top-view of a preferred vortex filter embodiment in combination with a preferred aerator embodiment.

FIG. 13 contains a schematic illustration of another preferred embodiment of the instant vortex separator invention, wherein the lower extent terminates in a narrowing cone-shaped debris reservoir.

FIG. 14 contains a schematic illustration of another preferred embodiment, wherein the diffuser is utilized to provide a smooth flow of water for use in an ornamental pond waterfall.

FIGS. 15a and 15B contain some preferred down pipe cross sections.

### DETAILED DESCRIPTION OF THE PREFERRED EMBODIMENTS

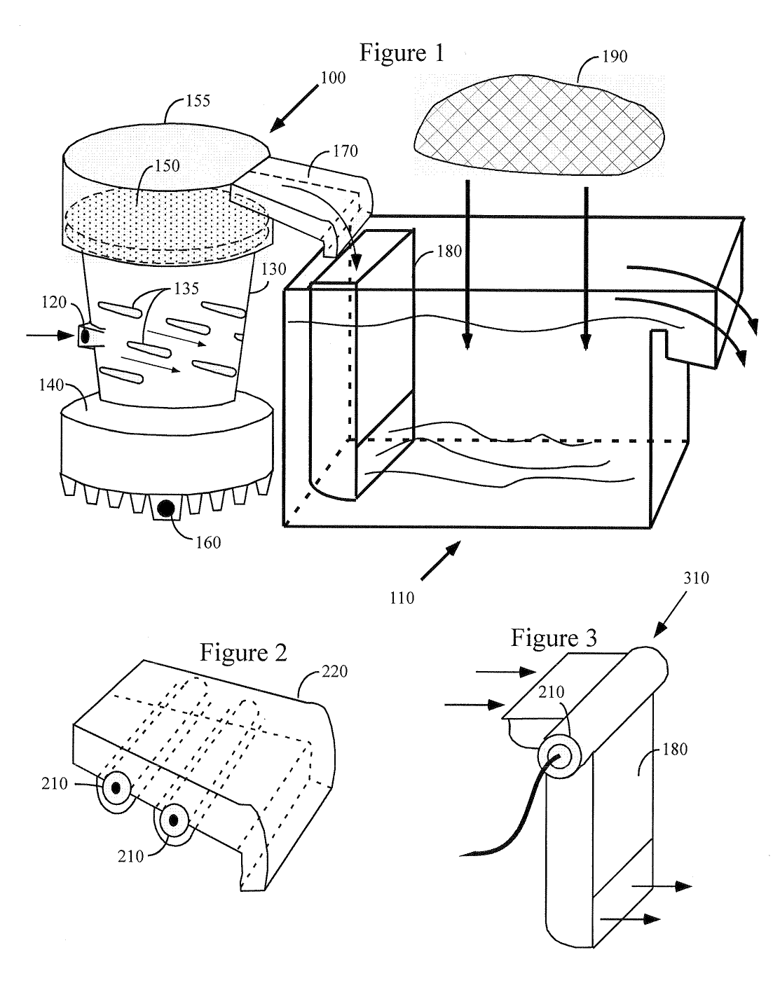

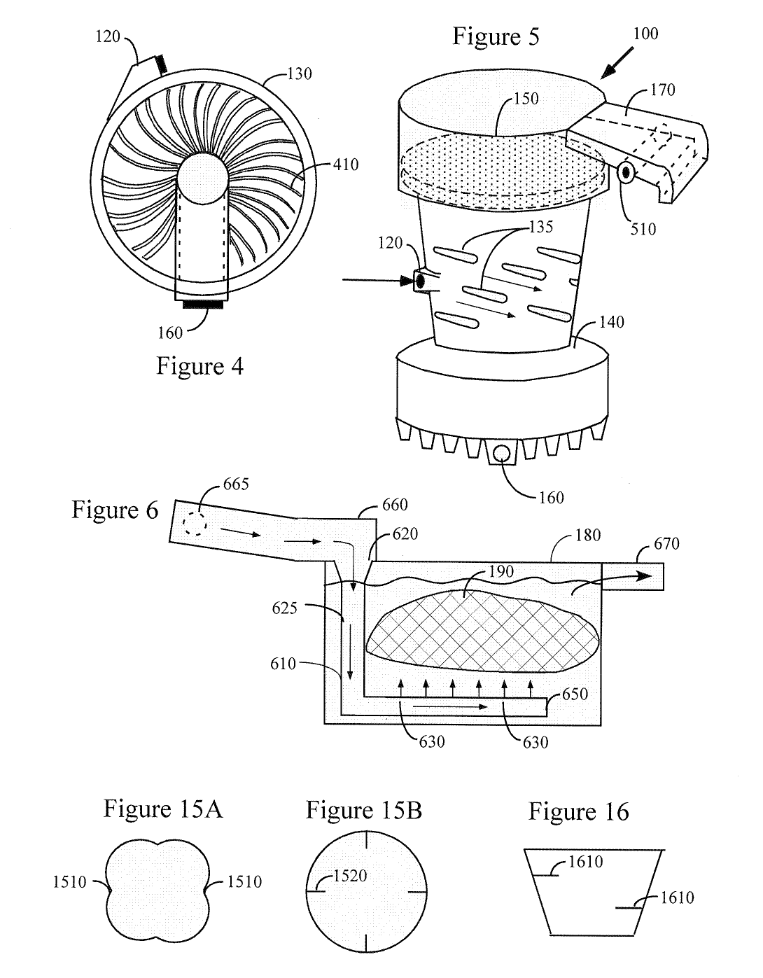

Turning first to FIG. 1, wherein various aspects of a preferred embodiment of the instant invention are illustrated, there is provide a sedimentation chamber (vortex solid separator 100) which will preferably be used in conjunction with a skimmer/filter combination 110 of the sort traditionally utilized in ornamental ponds. In a preferred arrangement, the instant vortex solids separator 100 utilizes directed fluid flow to create a peripheral water circulation pattern within a generally cylindrical body 130 (i.e., a body that is for the most part round in cross section). Preferably, water intake port 120 will be oriented such that water entering the unit 100 will do so at an angle that is roughly parallel to the inner surface of the body 130, thereby tending to impart a circular motion to the water contained inside. Note that the preferred body 130 is round in cross section but in the embodiment of FIG. 1 is not strictly cylindrical (i.e., having a constant radial cross section throughout). As is indicated in FIG. 1, the body 130 of the instant invention may taper toward one end or the other. For purposes of the specification and the claims that follow, the term “generally cylindrical” will be used to mean a body that is at least approximately circular in cross section throughout whether or not it is a true cylinder.

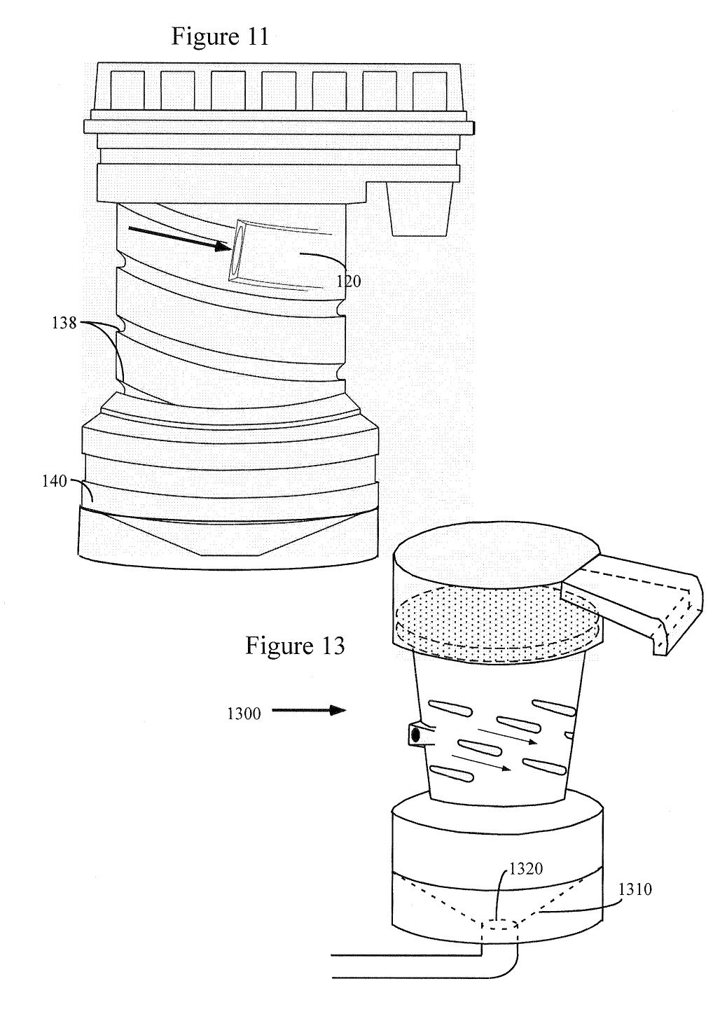

In the embodiment of FIG. 1, along the inner surface of the body 130 will preferably be a number of directionally oriented inwardly projecting fins 135 which are preferably sloped in a downward direction. One purpose of such fins 135 is to urge the circulating water that is moving near the inner surface of the body 130 within the separator 100 in a generally downward direction. In some preferred embodiments, the fins of FIG. 1 will be replaced by one or more internally projecting ridges 138 that wrap continuously around the inner surface of the body 130 (FIG. 11), i.e., the fins 130 will continuously extend around the interior of the body 130. This is just one of many alternative configurations that are potentially usable with the instant invention. That being said, whether they are fins 135 or ridges 138, it is important that the structure that is chosen serve to urge the water entering this embodiment in a downward direction. Thus, for purposes of the instant application and the claims hereinafter, the term “ridge” will be used to refer both to continuous ridges 138 and discontinuous ridges (e.g., fins 135).

At the lower terminus of the body 130 is a water reservoir (base 140) which preferably has an increased size (e.g., a larger circumference or, more generally, a larger perimeter) as compared with the upper portion of the filter. A principal reason for the use of this sort of structure is that when the circulating water enters the larger base 140, it will tend to decrease in velocity, thereby creating a zone of relatively snow-moving or motionless water. As water enters this zone within the base 140, solids that are suspended therein will tend to fall to the bottom of the vortex separator 100. Note that, although in the preferred embodiment the base 140 is round in cross section, that is not essential and other cross sectional shapes (e.g., square, octagonal, rectangular, etc.) could certainly be used in the alternative. However, the preferred embodiment of the base 140 is illustrated in FIG. 1 and takes the form of a generally cylindrical shape.

Then, the water which has been relieved of much of its solid contaminants will tend to make its way up through the center of the separator 100 where it will preferably pass through a mat-type filter 150 and into an upper reservoir 155 before being discharged (e.g., either back into the pool or into another water treatment component such as filter box 110) via snout 170.

In one preferred embodiment, the base 140 of the vortex separator 100 will be equipped with multiple internal grooves 410 that are designed to channel debris toward an outlet 160 that can be used to back flush the system 100 for purposes of removing sediments deposited at its bottom. In other preferred embodiments, the debris collection surface 1310 will be smoothly tapering and preferably in the shape of a cone (see FIG. 13) with an outlet 1320 at the bottom through which debris that have collected therein can be withdrawn when the separator 1300 is backwashed or otherwise cleaned.

In one preferred variation of the instant invention, the snout 170 will be modified by placing one or more UV lights 210 therein (see, modified snout 220, FIG. 2). A central purpose of such light sources 210 is to assist in the process of neutralizing harmful contaminants such as bacteria that might be found within the water. Vertical water pathway 180 can similarly be modified by inclusion of a UV light 210 (see, e.g., modified vertical pathway 310, FIG. 3).

Turning next to FIG. 6, according to a another aspect of the instant invention, there is provided herein an aerator system 610 for use with an ornamental pond or the like. In a preferred embodiment, water will be deposited via a water input line 665 into a water intake receptacle 660 which will typically be inclined toward a water accumulating structure such as a filter 180. Although the intake receptacle might be in any number of different shapes and configurations, in a preferred embodiment it will have a flat base, although other configurations (e.g., undulating, textured, etc.) are certainly possible.

Preferably, on the downhill end of the water receptacle 660 will be a plurality of rectangular apertures/water ducts 620 that drain the receptacle 660 and allow the water to fall into a cylindrical (or other shaped) downwardly extending pipe (down pipe 625) that continues vertically downward for some distance beneath the surface of the water in an adjacent water reservoir (e.g., filter 180, FIG. 6) before transitioning into a horizontal orientation. Although the down pipe 625 is preferably rectangular (e.g., square) in cross section, other possibilities are certain possible and have been considered by the inventor. For example, FIGS. 15A and 15B illustrate two preferred cross section configurations, both of which are designed to increase the turbulence of the water as it falls. In the case of FIG. 15A, the down pipe 625 has a clover-like cross sectional shape, the internal indentations 1510 being designed to create additional turbulence in water falling therein. Similarly, the fins 1520 of FIG. 15B are also intended to encourage turbulence in the falling water. Preferably, the water will fall some distance before encountering the water level of the reservoir (filter 180). Other things being equal, the further that the water falls, the greater the amount of aeration that will result. Preferably, the distance that the water falls will be at least several inches.

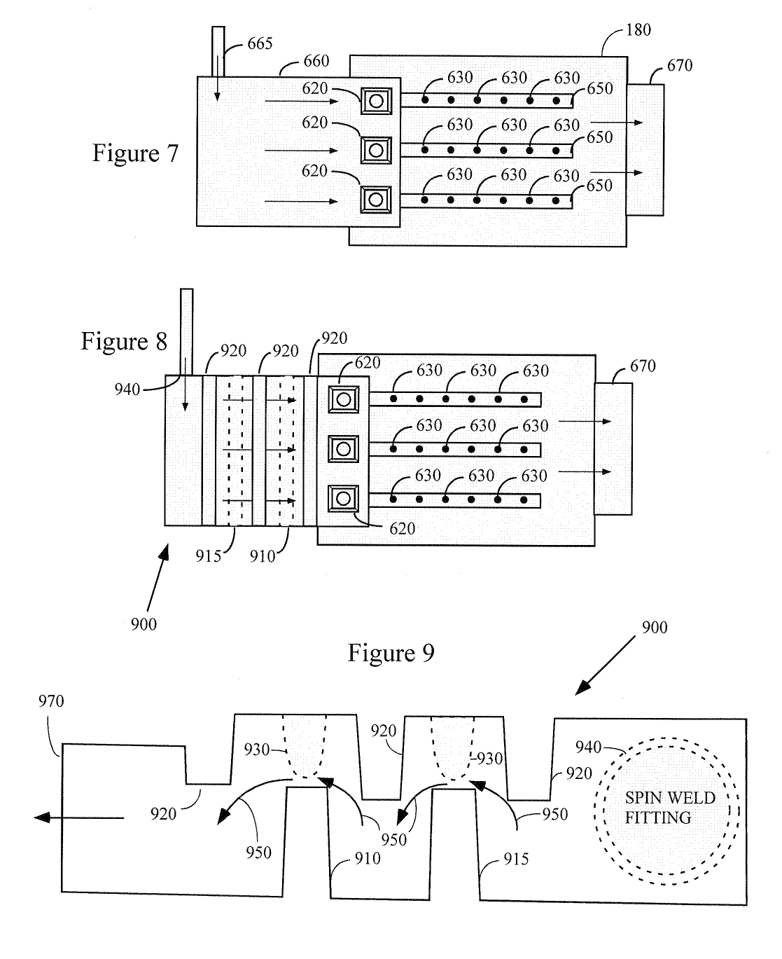

The distribution line 650 of the instant aerator 610 is preferably equipped with a series of holes 630 that allow air and water to escape into the water reservoir. See FIGS. 6 and 7. In the preferred arrangement, the distribution line 650 will be either at least roughly horizontal or sloping upward to the right in FIG. 6. One advantage of utilizing a slight upward slope in the distribution line 650 is that would tend to allow air bubbles to help move aerated water further down the length of distribution line 650 and into the reservoir 180. Although in the preferred embodiment a plurality of holes 630 will be utilized (as is generally indicated in, for example, FIGS. 7 and 8), it is important that at least one hole 630 be present in each distribution line 650.

Preferably the water reservoir 180 that is aerated will be a filter that contains biological filter media 190 of some sort. In many instances, a snout 670 will be provided to create an artificial waterfall that returns water back into the ornamental pond from which it originated.

In operation, water that enters the down pipe 625 of the instant aeration system 610 via the ducts 620 will bring along with it at least some air bubbles that were captured as the water fell into the down pipe 625. Note, of course, that although in the preferred embodiment the pipe 625 will be a conventional cylindrically shaped water passageway, it need not be in that shape and could have, for example, a square or other cross sectional shape. To this end, the inventor has determined that the presently preferred design of the duct 620 is a rectangle or other shape which has relatively abrupt changes in direction along its perimeter (e.g., at each vertex). See, for example, the embodiment of FIG. 12. That is, the instant inventor has determined that smooth aperture shapes (e.g., circular, ellipsoidal, etc.) do not seem to generate as much turbulence as the water falls therethrough as compared with rectangular (or, e.g., triangular, pentagonal, hexagonal, etc.) ones. As a consequence, the amount of aeration that is observed when the duct openings 620 are rectangular seems to be greater than is seen in cases where the openings have smoother perimeters and, thus, rectangular is the preferred shape. By way of example, the schematic cross section of a preferred duct 620 illustrated in FIG. 16 contains a number of horizontal platforms 1610 placed therein which are designed to further increase the turbulence of the falling water.

That being said, an essential feature of the instant invention is that the water that is leaving through the ducts 620 must fall some distance (e.g., a few inches) into the reservoir below in order to capture air therein and to provide a mechanism for forcing that air downward into the receiving body of water.

Water that falls into the downwardly extending pipe 625 will carry oxygen with it in the form of bubbles and additional dissolved oxygen suspended therein. The water then is carried by momentum and gravity through the downwardly extending pipe 625 and into the horizontal pipe 650. Excess oxygen that has been forced downward through the pipe 625 will then typically be released in the form of bubbles that rise up into the reservoir (e.g., water-filled filter 180) preferably through holes 630 which have been provided along the length of horizontal pipe 650. Of course, water will also exit via these same holes. Preferably, the bubbles will percolate upward from the horizontal pipe 650 through filter media 190, thereby encouraging aerobic bacteria colonization.

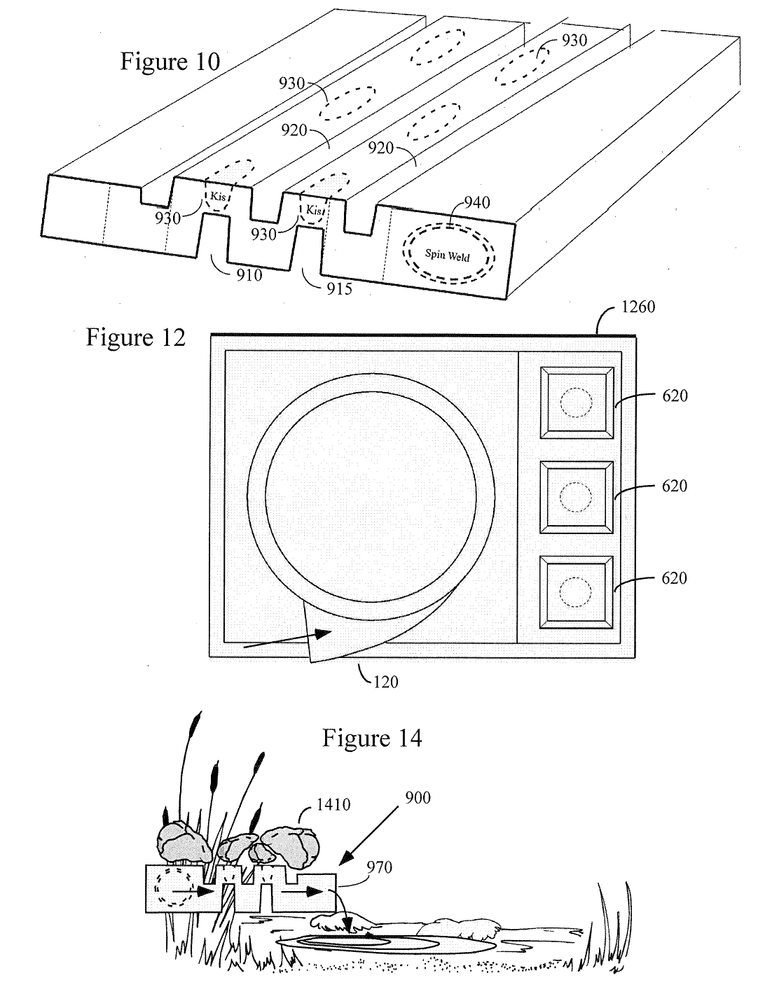

Finally, in still another preferred embodiment there is provided a diffuser 900 which is designed to provide a smooth flow of fluid into a structure such as the aerator (e.g., FIG. 8) or, alternatively, to provide a smooth flow of water for use in creating pleasing waterfall effects. (See, e.g., the configuration of FIGS. 8, 9, and 10 of that of FIG. 14). Preferably, the diffuser will contain a plurality of horizontally spaced apart vertical dividers or barriers, some of which extend upwardly into the interior of the diffuser from its floor (floor barriers 910 and 915) and others of which extend downwardly from its cover (ceiling barriers 920), the net effect being to force water that is flowing therethrough to move in a non-linear fashion. This flow pattern will tend to slow down the progress of water through the diffuser 900 which will result in a more uniform distribution of the water as it exits from the diffuser 900. Of course, the water source is most likely to be a point source (e.g., via water input 940), so distributing the water across the full width of the output orifice will clearly create a more appealing waterfall display than would be the case if the water were allowed to take the most direct route from the input 940 to the exit. Also note that it is not essential that the upper barriers 920 substantially continuously span the interior of the diffuser 900. The function of the upper barriers 920 is to direct water downward in the event that the water level gets that high. On the other hand, the lower barriers 910/915 will preferably be substantially continuous in their span across the interior of the diffuser body. If the lower barriers 910/915 contain larger gaps, those gaps will tend to reduce the smoothness of the water that is released by the instant diffuser 900, thus, reducing its effectiveness.

Note that it is preferred that the upper 920 and lower 910/915 barriers should be alternating and offset relative to each other so as to create a tortuous flow path 950 through the device 900. Additionally, it is preferred that the upper barriers 920 should extend downward past the level of water in the diffuser 900, else they will not modify the flow path. In practice, in the preferred embodiment the upper barriers 920 should extend downward to a distance from the floor not substantially less than the height of the lower barriers 910/915. See, for example, the arrangement of FIG. 9. Finally, although FIG. 9 suggests that the upper and lower barriers should be flat on their respective termini, obviously other arrangements (e.g., rounded) are certainly possible and have been considered by the instant inventor. Additionally, in the preferred arrangement the barriers will be made of a material that is impermeable to the flow of water there through. That being said, other variations (e.g., use of semi-permeable material) are certainly possible and have been contemplated by the instant inventor.

In practice, water will enter diffuser 900 via water input orifice 940. The water will initially collect against first barrier 915 and rise until it overflows, at which time the water will then begin to collect against second divider 910. Eventually, water will spill over the top of second barrier 910 and, if there are no further barriers, flow out of the system. If the volume of water is sufficiently high, the level of water within the diffuser 900 will encounter ceiling barriers 920. As is generally indicated in FIG. 9, water that is flowing through the diffuser 900 when it is near its maximum capacity will be tend to move in a serpentine fashion, thereby retarding its progress through the device.

In a preferred embodiment the upper 920 and lower 910 barriers will be at least roughly parallel to each other and both will be oriented at least approximately parallel to the diffuser opening 970. One reason for aligning the barriers in this manner is that this orientation tends to produce smoother outflow stream than would otherwise be obtained. Note that, especially in the case of the upper barriers 920, this sort of parallel orientation is not strictly required. However, the instant inventor has determined that this arrangement typically produces the smoothest outflow water stream.

One preferred application for which the instant diffuser 900 is particularly well suited is for use in conjunction with a waterfall feature of the sort that is often found in ornamental ponds. As is generally illustrated in FIG. 14, in one preferred arrangement the diffuser 900 will be provided with a water source and situated above and proximate to an ornamental pond so that water that leaves the instant invention will fall directly (or indirectly) into the pond. As is indicated in FIG. 14, often pond owners want to camouflage or otherwise reduce the visual impact the diffuser 900 by adding ornamental rocks 1410 or other materials to the top of it. This helps to create an impression that the water that is issuing therefrom is a natural waterfall feature. Of course, ornamental rocks 1410 can be rather heavy depending on their size. The presence of one or more support members 930 are designed to help to prevent the diffuser 900 from collapsing under the weight of the overburden camouflage. Of course, the support member 930 could alternatively be positioned on the floor of the diffuser 900 and the upper barriers 920 would then rest on them. Further, the supper members 930 could be placed on both the floor and ceiling of the diffuser 900 and come to rest, respectively, against the upper 920 and lower 910 barriers. Finally, in some instances a support member 390 will be configured to be in continuous contact with the floor or ceiling barrier opposite it. In other cases, the support member 930 will not contact the barrier that is opposite it until a weight is placed on the top of the diffuser 900 and its ceiling flexes downward in response. It is important, though, that the support members 930 not disrupt the smooth flow of water there through unduly.

Another preferred application for the instant diffuser 900 is when it is used in conjunction with aerator 610 (e.g., FIG. 8). At lower water-flow levels, the diffuser 900 will tend to distribute water that is coming into the aerator 610 horizontally across the width of the diffuser 900. This will, of course, typically result in a more even distribution of water between the three apertures 620. Absent the diffuser 900, water could tend to run directly from input orifice 940 into only one of the apertures 620. Thus, use of the diffuser 900 will potentially increase the efficiency and aeration effectiveness of aerator 610.

### CONCLUSIONS

There has been provided herein an improved system for filtering and aerating water that is held within ornamental pools and the like. Of course, the instant inventor has contemplated many variations of the particular embodiments discussed herein, which would be within the scope of the claims that follow.

It should be noted that the term “filtering” as used herein should also be broadly construed to include the removal of debris of any size from the water, including very large (e.g., leaves) as well as very small (e.g., dust and dirt) particles from the water.

While the inventive device has been described and illustrated herein by reference to certain preferred embodiments in relation to the drawings attached hereto, various changes and further modifications, apart from those shown or suggested herein, may be made therein by those skilled in the art, without departing from the spirit of the inventive concept, the scope of which is to be determined by the following claims.

What is claimed is:

1. An apparatus for delivering water to a water reservoir, comprising:
(a) an enclosure, said enclosure having a ceiling, a floor, a width, a front, a rear, a water intake orifice and, a water discharge orifice, said water discharge orifice being situated within said front of said enclosure and at least for emptying water into the water reservoir;
(b) a plurality of lower barriers situated on said enclosure floor and spanning said width of said enclosure, each of said lower barriers at least for retarding a flow of water from said water intake orifice to said water discharge orifice, wherein
(i) each of said lower barriers has a terminus below said enclosure ceiling,
(ii) each of said lower barriers oriented to be at least approximately parallel to the other, and,
(iii) each of said lower barriers is situated between said water intake orifice and said front of said enclosure; and,
(c) a plurality of upper barriers situated on said enclosure ceiling, wherein
(i) each of said upper barriers is proximate to at least one of said lower barriers;
(ii) each of said upper barriers has a terminus above said enclosure floor, each of said upper barrier termini extending downward at least as far as a height of at least one of said at least one proximate lower barrier termini,
(iii) each of said upper barriers is at least approximately parallel to the other, and,
(iv) each of said barriers is situated between said water intake orifice and said front of said enclosure.

2. An apparatus for delivering water to a water reservoir according to claim 1, further comprising:
(d) at least one support member situated on said enclosure ceiling, each of said at least one support members being situated opposite one of said at least one lower barriers, and each of said at least one support members at least serving to support said enclosure ceiling when a weight is placed thereon.

3. An apparatus for delivering water to a water reservoir according to claim 2, wherein said at least one support member is situated opposite one of said at least one lower barriers and is in continuous contact therewith.

4. An apparatus for delivering water to a water reservoir according to claim 1, wherein said lower barriers are constructed of a material that is impermeable to the flow of water therethrough.

5. A water aeration device, comprising:
(a) a water receptacle situated above a water reservoir;
(b) a water source emptying into said water intake receptacle;
(c) a water duct in a floor of said water receptacle, said water duct being at least for draining water from said water receptacle;
(d) a down pipe in fluid communication with said water duct, said down pipe at least for transferring water from said duct to said water reservoir, said down pipe having a first end and a second end, wherein
(i) said first end is situated above a water level in the reservoir,
(ii) said second end is situated below the water level in the reservoir, and,
(iii) water entering via said first end must fall a predetermined distance before, encountering the water level in the reservoir, thereby aerating the entering water; and,
(e) a distribution line in fluid communication with said second end of said down pipe, said distribution line extending away from said second end of said down pipe and into said reservoir, said distribution line having at least one holes on an upper surface thereof, said plurality of holes being at least for releasing the aerated water into the reservoir.

6. A water aeration device according to claim 5, wherein said water duct is rectangular in cross section.

7. A water aeration device according to claim 5, wherein said down pipe is circular in cross section.

8. A water aeration device according to claim 5, further comprising:
(f) a filter media, said filter media being positionable to be within said water reservoir and above said distribution line.

9. A water aeration device, comprising:
(a) a water receptacle situated above a level of water in a reservoir;
(b) a water source emptying into said water receptacle;
(c) a plurality of water ducts in a floor of said water receptacle, each of said water ducts being at least for draining water from said water receptacle,
(i) wherein each of said water ducts has a down pipe in fluid communication therewith,
(ii) wherein each of said down pipes has a first end and a second end, said first end being situated above the water level in the reservoir, said second end being situated below the water level in the reservoir, such that water entering at said first end must fall a predetermined distance before arriving at the reservoir water level, thereby aerating the water; and,
(d) a plurality of distribution lines, each of said distribution lines being associated with at least one of said down pipes, wherein,
(i) each of said distribution lines is in fluid communication with an associated second end of said associated down pipe,
(ii) each of said distribution lines extends away from said associated second end of said associated down pipe,
(iii) each of said distribution lines has at least one hole on an upper surface thereof, said at least one hole being at least for releasing aerated water from said associated down pipe into the reservoir.

10. A water aeration device according to claim 9, further comprising:
(e) a filter media, said filter media being positionable to be within said water reservoir and above said plurality of distribution lines.

11. A solids separator for use with an ornamental pond, comprising:
(a) a generally cylindrical body having a body interior, an upper body end, a lower end, a body perimeter of said lower end, and a body inner surface, said body inner surface having at least one inwardly projecting ridge thereon, said at least one ridge being oriented to urge circulating water within said body to move in a downward direction;
(b) a reservoir affixed to said lower end of said cylindrical body and in fluid communication therewith, said reservoir having a reservoir perimeter greater than said body perimeter of said lower end, said reservoir being at least for providing an opportunity for solids within the water to settle out;
(c) a water intake port positioned on said body and in fluid communication with said body interior, said water intake port being oriented such that water that is added to the body interior via said intake port urges the water within said body to rotate;
(d) an upper reservoir affixed to said upper body end and in fluid communication therewith;
(e) a snout in fluid communication with said upper reservoir, said snout at least for discharging water that has passed into said upper reservoir from said body; and,
(f) a filter situated between said body and said snout, said filter at least for filtering water flowing in from said body and out through said snout.

12. A solids separator for use with an ornamental pond according to claim 11, wherein there are a plurality of inwardly projecting ridges, each of said plurality of ridges being oriented to urge circulating water within said body to move in a downward direction toward said reservoir.

13. A solids separator for use with an ornamental pond according to claim 11, wherein said reservoir is strictly cylindrical in shape.

14. A solids separator for use with an ornamental pond according to claim 11, further comprising:
(g) a water outlet in fluid communication with said reservoir, said water outlet being configurable to permit withdrawing water from said reservoir.
